(19) United States
(12) Patent Application Publication
(10) Pub. No.: US 2021/0279419 A1
(43) Pub. Date: Sep. 9, 2021

(54) METHOD AND SYSTEM OF EXTRACTING VOCABULARY FOR IMAGERY OF PRODUCT

(71) Applicant: CHINA ACADEMY OF ART, Hangzhou (CN)

(72) Inventors: Zheng LIU, Hangzhou (CN); Zhixuan CHEN, Hangzhou (CN); Yujing WANG, Hangzhou (CN); Yun WANG, Hangzhou (CN); Huijun HU, Hangzhou (CN)

(21) Appl. No.: 17/035,457

(22) Filed: Sep. 28, 2020

(30) Foreign Application Priority Data
Mar. 9, 2020 (CN) 202010156718.5

(51) Int. Cl. G06F 40/30; G06Q 30/02; G06F 16/35; G06F 40/279; G06F 40/253

(52) U.S. Cl. CPC G06F 40/30; G06Q 30/0201; G06F 40/253; G06F 40/279; G06F 16/35

(57) ABSTRACT

A method and a system for extracting vocabulary for imagery of a product, including: collecting a comment text data of a target product, segmenting the comment text data to obtain an evaluation vocabulary; extracting a high-frequency word used to evaluate an appearance as a central word from the evaluation vocabulary, and extracting an adjective from the evaluation vocabulary to obtain the adjectives; converting the evaluation vocabulary into a word vector, calculating a similarity between each adjectives and the central word based on the word vector, extracting a corresponding adjectives according to the similarity as an original vocabulary for imager; clustering the original vocabulary for imagery, exacting the corresponding original vocabulary for imagery according to a clustering result as a vocabulary for imagery, which can extract the vocabulary for imagery based on the comment text data, reduce the labor cost, and improve the extraction efficiency.

### CROSS-REFERENCE TO RELATED APPLICATIONS

This Non-provisional application claims priority under 35 U.S.C. § 119(a) on Chinese Patent Application No(s). CN2020101567185 filed on Mar. 9, 2020, the entire contents of which are hereby incorporated by reference.

### BACKGROUND OF THE INVENTION

### Field of the Invention

The invention relates to a field of computer-aided design, in particular to a method and a system of extracting vocabulary for imagery of a product.

### Description of the Related Art

In view of the increasingly intense emotional needs to the products of consumers, designers need to accurately capture the user needs in the design process of product appearance in order to design products to meet the user emotional needs.

Facing of a product, users usually use their own kansei imagery model to match and to evaluate, at this time, they will use some vocabulary for imagery, such as “beautiful” “luxurious” and so on. The traditional way to extract vocabulary for imagery is to invite a number of experts with semantic learning background and background in the field of the product to conduct classification and extraction after the preliminary screening of the relevant vocabulary for imagery collected by the Card sorting. This method has a high labor cost, too much dependence on experts, a large subjective component, too many interference factors, and is not conducive to the processing of a large number of words. It is unable to extract imagery vocabulary from a large number of words, imagery vocabulary can not be extracted from a large number of users' perceptual intention samples, which is out of step with the technology in the big data era.

### BRIEF SUMMARY OF THE INVENTION

The invention provides a method and a system of extracting vocabulary for imagery of a product aiming at the defects of the existing technology.

In order to solve the above technical problem, the invention adopts the following technical scheme:

The invention provides a method of extracting vocabulary for imagery of a product, which includes the following steps:

Collecting a comment text data of a target product, and segmenting the comment text data to obtain an evaluation vocabulary;

extracting a high-frequency words used to evaluate an appearance as a central word from the evaluation vocabulary, and extracting an adjective from the evaluation vocabulary to obtain the adjectives; converting the evaluation vocabulary into a word vector, calculating a similarity between each adjectives and the central word based on the word vector, and extracting a corresponding adjectives according to the similarity as an original vocabulary for imagery; and clustering the original vocabulary for imagery, and exacting the corresponding original vocabulary for imagery according to a clustering result as a vocabulary for imagery.

As an implementable embodiment, calculating a similarity between each adjectives and the central word based on the word vector, and extracting a corresponding adjectives according to the similarity as an original vocabulary for imagery includes:

calculating a cosine similarity between the word vector corresponding to the central word and the word vector corresponding to each adjectives, taking a calculation result as the similarity between the central word and the adjectives; extracting the adjectives having a similarity exceeding a preset similarity threshold as a related word, and obtaining a word frequency of each related word occurring in the evaluation vocabulary;

merging the related words corresponding to each central word, extracting the related words with the word frequency exceeding a preset word frequency threshold, and obtaining the original vocabulary for imagery.

As an implementable embodiment, clustering the original vocabulary for imagery, and exacting the corresponding original vocabulary for imagery according to a clustering result as a vocabulary for imagery including:

calculating a clustering number based on the word vector of the original vocabulary for imagery; clustering the original vocabulary for imagery according to the word vector of the original vocabulary for imagery, obtaining a corresponding number of clusters and obtaining a cluster center of each cluster, extracting the original vocabulary for imagery closest to the cluster center of each cluster, and generating and outputting the vocabulary for imagery.

As an implementable embodiment, extracting a high-frequency word used to evaluate an appearance as a central word from the evaluation vocabulary, and extracting an adjective from the evaluation vocabulary to obtain the adjectives including:

classifying the evaluation vocabulary according to a part of speech, extracting the evaluation vocabulary with part of speech as an adjective to obtain the adjectives, and extracting the evaluation vocabulary with part of speech as an noun or a verb; eliminating a word referring to the target product from a extracted nouns and a extracted verbs and obtaining a basic word;

counting a word frequency of each basic word in the evaluation vocabulary, extracting a corresponding basic word according to the word frequency to obtain high-frequency words, and selecting a word for evaluating appearance and filtering out from the high-frequency words as the central word.

As an implementable embodiment, the evaluation vocabulary is converted into a word vector based on word2vec model.

As an implementable embodiment, clustering the original vocabulary for imagery, and exacting the corresponding original vocabulary for imagery according to a clustering result as a vocabulary for imagery is followed by a visualization processing step, and the step includes: performing dimension reduction processing on the word vector of the original vocabulary for imagery to obtain a corresponding coordinate point;

mapping the coordinate point to a two-dimensional plane according to a clustering result, and generating and outputting a space map of a vocabulary for imagery.

The invention also provides a system of extracting vocabulary for imagery of a product, which include:

a corpus acquisition module is used for acquiring the evaluation vocabulary, collecting a comment text data of a target product, and segmenting the comment text data to obtain an evaluation vocabulary;

a pre-extraction module for extracting a high-frequency word used to evaluate an appearance as a central word from the evaluation vocabulary, and extracting an adjective from the evaluation vocabulary to obtain the adjectives; converting the evaluation vocabulary into a word vector, calculating a similarity between each adjectives and the central word based on the word vector, and extracting a corresponding adjectives according to the similarity as an original vocabulary for imagery;

a extraction module for clustering the original vocabulary for imagery, and exacting the corresponding original vocabulary for imagery according to a clustering result as a vocabulary for imagery.

As an implementable embodiment, the pre-extraction module includes a first vocabulary extraction unit and a second vocabulary extraction unit;

the first vocabulary extraction unit is configured to:

classifying the evaluation vocabulary according to a part of speech, extracting the evaluation vocabulary with part of speech as an adjective to obtain the adjectives, and extracting the evaluation vocabulary with part of speech as an noun or a verb; eliminating a word referring to the target product from a extracted nouns and a extracted verbs and obtaining a basic word;

counting a word frequency of each basic word in the evaluation vocabulary, extracting a corresponding basic word according to the word frequency to obtain high-frequency words, and selecting a word for evaluating appearance and filtering out from the high-frequency words as the central word;

the second vocabulary extraction unit is configured to:

calculating a cosine similarity between the word vector corresponding to the central word and the word vector corresponding to each adjectives, taking a calculation result as the similarity between the central word and the adjectives; extracting the adjectives having a similarity exceeding a preset similarity threshold as a related word, and obtaining a word frequency of each related word occurring in the evaluation vocabulary;

merging the related words corresponding to each central word, extracting the related words with the word frequency exceeding a preset word frequency threshold, and obtaining the original vocabulary for imagery.

As an implementable embodiment, it also includes a space map generation module which is configured to:

performing dimension reduction processing on the word vector of the original vocabulary for imagery to obtain a corresponding coordinate point;

mapping the coordinate point to a two-dimensional plane according to a clustering result, and generating and outputting a space map of a vocabulary for imagery.

The invention also provides a computer readable storage medium which stores a computer program, the program is executed by a processor to implement the steps of any of the above-mentioned methods.

The invention has obvious technical effects because of adopting the above technical schemes: the invention segment the comment text data of a target product collected to obtain an evaluation vocabulary, extract a high-frequency word used to evaluate an appearance as a central word from the evaluation vocabulary, so the central word can reflect the user's focus on the appearance of the target product. Then, calculate a similarity between each adjectives and the central word based on the word vector, and extract a corresponding adjectives according to the similarity as an original vocabulary for imagery, cluster the original vocabulary for imagery, and get the most representative vocabulary for imagery. Compared with the technical scheme of artificially determining vocabulary for imagery in the existing technology, the sample quantity of the comment text data is not limited by the staffs processing ability, and it has strong expansibility and can extract the perceptual imagery vocabulary objectively and accurately, not subject to the subjective impact of staff, reduce labor costs while improving extraction efficiency.

### BRIEF DESCRIPTION OF THE DRAWINGS

In order to give a clearer explanation of this invention embodiment or the technical scheme in the existing technology, the appended drawings required to be used in the embodiment or the existing technology description are briefly introduced below. Obviously, the drawings in the following description are only some embodiments of the invention, and other drawings can be obtained without creative labor for ordinary technicians in this field.

FIG. 1 is a flow diagram of a method of extracting vocabulary for imagery of a product;

FIG. 2 is a flow diagram of a method of extracting vocabulary for imagery of the product in embodiment one.

FIG. 3 is a line relationship of SSE and K in one embodiment;

FIG. 4 is a vocabulary for imagery space map for a gas stove in one embodiment;

FIG. 5 is a module connection diagram of a system for extracting vocabulary for imagery of a product.

### DETAILED DESCRIPTION OF THE INVENTION

The invention is further explained in detail in conjunction with an embodiment, which is an interpretation of the invention and which is not limited to the following embodiment.

### Embodiment One

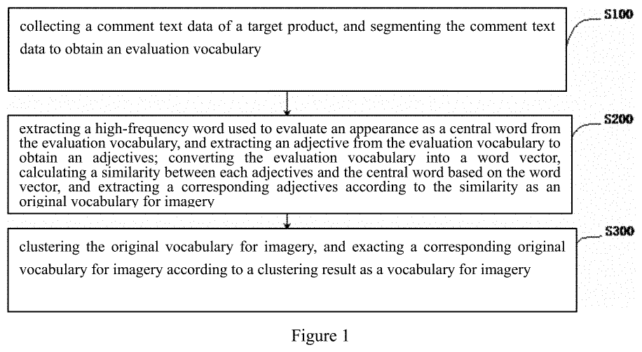

A method of extracting vocabulary for imagery of a product, as shown in FIG. 1, including the following steps:

S100: collecting a comment text data of a target product, and segmenting the comment text data to obtain an evaluation vocabulary;

S200: extracting a high-frequency word used to evaluate an appearance as a central word from the evaluation vocabulary, and extracting an adjective from the evaluation vocabulary to obtain an adjectives; converting the evaluation vocabulary into a word vector, calculating a similarity between each adjectives and the central word based on the word vector, and extracting a corresponding adjectives according to the similarity as an original vocabulary for imagery;

S300: clustering the original vocabulary for imagery, and exacting a corresponding original vocabulary for imagery according to a clustering result as a vocabulary for imagery.

From the above, the embodiment segment the comment text data of a target product collected to obtain an evaluation vocabulary, extract a high-frequency word used to evaluate an appearance as a central word from the evaluation vocabulary, so the central word can reflect the user's focus on the appearance of the target product. Then, calculate a similarity between each adjectives and the central word based on the word vector, and extract a corresponding adjectives according to the similarity as an original vocabulary for imagery, cluster the original vocabulary for imagery, and get the most representative vocabulary for imagery. Compared with the technical scheme of artificially determining vocabulary for imagery in the existing technology, the sample quantity of the comment text data is not limited by the staffs processing ability, and it has strong expansibility and can extract the perceptual imagery vocabulary objectively and accurately, not subject to the subjective impact of staff, reduce labor costs while improving extraction efficiency.

In step S100: the specific step of collecting the comment text data of the target product are as follows:
through the existing crawler technology, an original comment text data of target products are collected from the shopping websites (JD.com, TMALL, Taobao, and so on);
filtering consistent data and meaningless content (such as “favorable comment”) from the original comment text data, removing unnecessary information such as time, picture, user name, product color, etc., and meaningless words such as comment, additional comment, and so on, to obtain effective comment text, that is, comment text data.

Note: In this embodiment, the original comment text data is filtered using a Python tool.

In Step S200, calculating a similarity between each adjectives and the central word based on the word vector, and extracting a corresponding adjectives according to the similarity as an original vocabulary for imagery comprises:

calculating a cosine similarity between the word vector corresponding to the central word and the word vector corresponding to each adjectives, taking a calculation result as the similarity between the central word and the adjectives; extracting the adjectives having a similarity exceeding a preset similarity threshold as a related word, and obtaining a word frequency of each related word occurring in the evaluation vocabulary;

merging the related words corresponding to each central word, extracting the related words with the word frequency exceeding a preset word frequency threshold, and obtaining the original vocabulary for imagery.

Note: Calculating a cosine similarity between the two word vectors is an existing technology. In this embodiment, a cosine distance algorithm is used to calculate the cosine similarity, that is, the cosine similarity is a similarity of two word vectors.

Technicians in relevant fields can set the similarity threshold and the word frequency threshold by themselves according to actual needs. For example, in this embodiment, the similarity threshold is 0.3 and the word frequency threshold is 50.

Note: According to the actual needs of the technicians in this field, only extract a number of words with highest similarity as related words.

In this embodiment, the adjectives with too low frequency and without reference are filtered by the word frequency threshold, so that the adjectives extracted based on similarity can better reflect the kansei imagery of the user.

In Step S200, extracting a high-frequency word used to evaluate an appearance as a central word from the evaluation vocabulary, and extracting an adjective from the evaluation vocabulary to obtain the adjectives comprising:

classifying the evaluation vocabulary according to their parts of speech, extracting the words with parts of speech of adjectives, nouns and verbs respectively to obtain obtain the adjectives, the nouns, and the verbs;

eliminating a word referring to the target product from a extracted nouns; then calculating a frequency of the remaining nouns, adjectives, and verbs respectively, and taking N nouns and N verbs with the highest frequency as high-frequency words.

The words selected from the high-frequency words used to evaluate appearance are as the central words.

Note: In this specification, high-frequency vocabulary refers to the nouns/verbs whose word frequency is in the first N positions, and N is a positive integer, which can be set by the technicians in this field according to their actual needs. In this embodiment, N is set to be 20.

The method of selecting words used to evaluate appearance from high-frequency words include: artificial screening; establishing an appearance vocabulary database in advance, matching the high-frequency words with the words in the appearance vocabulary database, and outputting the high-frequency words that match successfully. In this embodiment, words used to evaluate appearance are extracted from 40 high-frequency words by means of artificial screening.

In this embodiment, the central word obtained by statistical analysis of the nouns and verbs of the evaluation vocabulary can reflect the user's focus on the appearance of the target product.

In this embodiment, the evaluation vocabulary is transformed into word vector based on word2vec model.

In Step S300, the specific step of clustering the original vocabulary for imagery, and exacting the corresponding original vocabulary for imagery according to a clustering result as a vocabulary for imagery are as follows:

calculating a clustering number based on the word vector of the original vocabulary for imagery;

clustering the original vocabulary for imagery according to the word vector of the original vocabulary for imagery, obtaining a corresponding number of clusters and obtaining a cluster center of each cluster, extracting the original vocabulary for imagery closest to the cluster center of each cluster, and generating and outputting the vocabulary for imagery.

Since there are near-synonyms in the original vocabulary for imagery, and a space distance and a numeric value of the near-synonyms are very close in the expression of the word vector, this embodiment makes the cluster analysis to the word vector of all the original vocabulary for imagery, in order to extract the most representative vocabulary for imagery from the words with similar and miscellaneous meanings.

Further, in step S300, clustering the original vocabulary for imagery, and exacting the corresponding original vocabulary for imagery according to a clustering result as a vocabulary for imagery is followed by a visualization processing step, and the step comprises: performing dimension reduction processing on the word vector of the original vocabulary for imagery to obtain a corresponding coordinate point;

mapping the coordinate point to a two-dimensional plane according to a clustering result, and generating and outputting a space map of a vocabulary for imagery.

In this embodiment, the visualization of the word vector of the original vocabulary for imagery can help the designer better understand the relationship between the original vocabulary for imagery, better understand the user requirements, and sum up the user requirements.

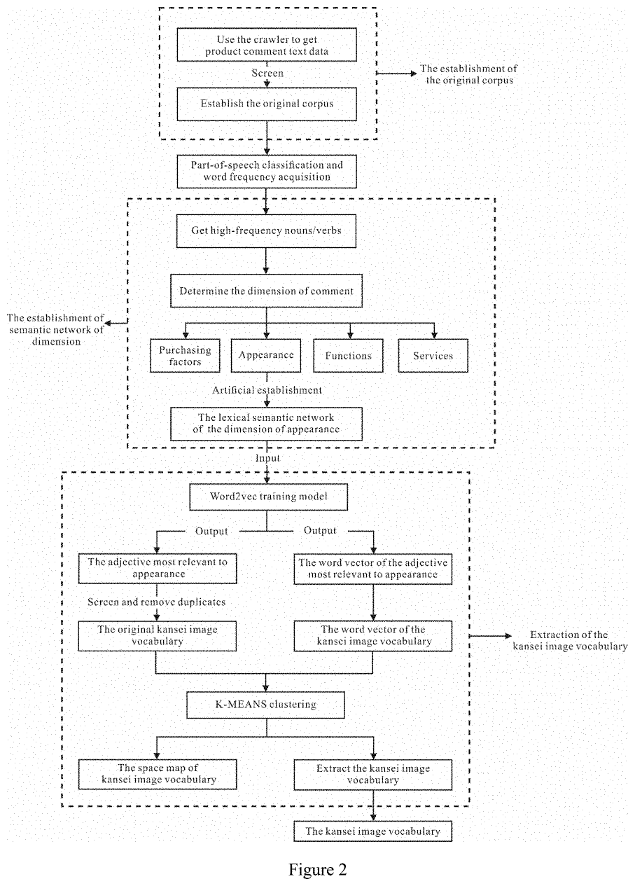

Please refer to FIG. 2, taking a gas stove as the target product, introduce in detail the specific steps of the method of extracting the vocabulary for imagery of product disclosed in this embodiment.

1. Corpus Acquisition:

1.1. The specific step of collecting the comment text data of the target product are as follows. Take “binocular gas stove” as a search keyword, search on the TMALL/JD.com, and choose to sort the search results according to the sales from high to low to form a product list. Then, the Python tool is used to crawl the comment data of the first 500 products in the product list formed by TMALL and jd.com, that is, to crawl the comment data of 500 products in TMALL and jd.com.

According to statistics, this embodiment covers 15 brands such as FOTILE, Robam, Supor, HOTATA, SETIR, Haier, VATTI, Midea, SACON, Zhujia, Opark, SIEMENS, Sakura and so on. The number of comments supported by Tmall and jd.com for each product to be displayed is only 1,000 at most. However, in the real process of crawling, since not every product displays 1,000 pieces of data (50,000 total comments, while the actual display is between 300 and 600 and does not show earlier comments), the total number of comments actually crawled is about 450,000.

Considering that users may copy and paste other comments, and some comments (such as “favorable comment”) have no actual content, comments like these should be filtered with the Python tool, leaving about 100,000 valid comments. Then, remove unnecessary information such as time, picture, user name, product color, etc., and meaningless words such as comment, additional comment, and so on, to generate comment text data. The original corpus is established based on the comment text data.

Some of the comment text data for gas stove are shown in Table 1:

TABLE 1

| Serial | Type of | |
|---|---|---|
| number | comment | Comment text data |
| 1 | Commentary | Good-looking, high-class, bought this to replace the original home |
| | appearance | that the stove. |
| | | Good! mother like, shape is also beautiful, fire energy size |
| | | adjustable, believe in the strength of the brand! |
| | | The reason I chose this stove, first of all, the brand of Joyoung is a |
| | | big brand, the quality is guaranteed, and second of all, this stove |
| | | appearance is very atmospheric, beautiful, glass panels, easy to |
| | | manage. |
| | | Consistent with the description, the style is also very novel, |
| | | foreign-style, want to buy friends can be assured to buy. |
| | | It's Nice, it's beautiful, it's generous, it's concise |
| | | Affordable Price, beautiful and generous, the Midea is trustworthy. |
| 2 | Comment the | The outer ring is packed with special yellow packing tape, the edges |
| | buying factor | and corners are protected by anti-collision frame, the paper skin is |
| | | thicker, the inner layer is fully wrapped with foam, the protection |
| | | panel and the special accessories are in a professional packing, |
| | | which saves the user from all kinds of worries during transportation. |
| | | The goods were just received in good packing and are very strong. |
| | | The brand of SUPOR is very attractive! Not a scratch on it. It's solid |
| | | as a rock. |
| 3 | Comment | Quality and cheap, very easy to use, eager to install their own, |
| | Service | installation and commissioning, small Lei patient guidance, serious |
| | | and responsible attitude of service, is worthy of praise! After-sales |
| | | hot phone inquiries about home installation, that we have installed, |
| | | busy ask the installation effect, whether the need for home service, |
| | | shelf life can be contacted at any time, good attitude, thank you, |
| | | satisfied shopping |
| | | Store service attitude is good, installation master are in advance to |
| | | contact me, do not worry about their own, express very powerful, the |
| | | next day to. This morning the installation master to me installed, just |
| | | cook a trial is very good, are blue fire, also gather fire, cooking very |
| | | fast. Very satisfied. Full marks. |
| 4 | Comment | SUPOR natural gas stove installed by the completion of the blue |
| | Function | flame power enough quality, good quality and cheap, the real |
| | | conscience of the business. |
| | | Gas Stoves are pretty good, first-level energy efficiency, energy |
| | | saving gas, firepower is also large, fine workmanship, The Adjuster |
| | | is good. |
| | | Very good stove, the flame is pure blue, the fire is very fast, the |
| | | work is also good, the protection function of flameout is very good, |
| | | after flameout and then wait for a few seconds to hear a small sound, |
| | | then automatically stop breathing, this function makes people feel |
| | | very relieved, especially for old people! |
| | | The gas stove is good, the fire color is also good, should be genuine. |
| | | Good quality and cheap price, suggest to buy. |
| | | He's got a lot of heat. He can cook and water fast |

1.2. Use the word segmentation tool of Jieba to segment the text data of each comment and obtain the evaluation vocabulary.

2. Original Vocabulary for Imagery Extraction:

2.1. Extracting a high-frequency word used to evaluate an appearance as a central word from the evaluation vocabulary, and extracting an adjective from the evaluation vocabulary to obtain the adjectives comprising:

2.1.1. Part-of-Speech Classification and Word Frequency Acquisition:

classifying the evaluation vocabulary according to their parts of speech by Python, extracting the words with parts of speech of adjectives, nouns and verbs respectively to obtain obtain the adjectives, the nouns, and the verbs;

eliminating a word referring to the target product, such as culling stove, gas cooker, gas stove, and so on; then calculating a frequency of the remaining words and taking 20 nouns and 20 verbs with the highest frequency as high-frequency words. The high-frequency words extracted in this embodiment are shown in Table 2.

TABLE 2

| Serial | | Word | | Word |
|---|---|---|---|---|
| number | Nouns | Frequency | Verbs | Frequency |
| 1 | Firepower | 24619 | Installation | 31620 |
| 2 | Mass. | 18439 | receive | 11389 |
| 3 | Logistics | 11180 | It's worth it | 10857 |
| 4 | Appearance | 7715 | Purchase | 7967 |
| 5 | Price | 6762 | Delivery | 7730 |
| 6 | Customer Service | 6125 | Express delivery | 6164 |
| 7 | Packing | 6099 | It works | 5609 |
| 8 | Speed | 5563 | Light it up | 4016 |
| 9 | Faceplate | 5204 | Fire it up | 3734 |
| 10 | Flame | 4036 | Decoration | 2605 |
| 11 | Service attitude | 3874 | Delivered | 2321 |
| 12 | After Sale | 3135 | Design | 1955 |
| 13 | Stainless steel | 3076 | Support | 1453 |
| 14 | Flame | 2626 | Description | 1444 |
| 15 | Brand | 2471 | Purging | 1393 |
| 16 | Function | 1765 | Turn off the engine | 1354 |
| 17 | Material Quality | 1663 | Distribution | 1325 |
| 18 | Styles | 1618 | Burning | 1297 |
| 19 | SCULPT | 1452 | LOAD IT UP | 1081 |
| 20 | Switch | 1140 | Load well | 1060 |

2.1.2. Determine the Dimension of Comment

As can be seen from Table 1, a dimension of comment includes appearance, purchasing factors, functions and services. The high-frequency words in Table 2 are summarized according to the above four dimensions, and the high-frequency words in the dimension of appearance include appearance, style, modeling, design and material.

Because only the vocabulary for imagery of the product form is extracted, and the factors such as color and material in the modeling elements are not considered, the words of material in the dimension of appearance are eliminated, to generate a lexical semantic network which includes appearance, style, modeling, design, that is, the central word is appearance, style, modeling and design.

2.2. Transforming the Evaluation Vocabulary into a Word Vector, Calculating a Similarity Between Each Adjectives and the Central Word Based on the Word Vector, and Extracting a Corresponding Adjectives According to the Similarity as an Original Vocabulary for Imagery

In this embodiment, the evaluation vocabulary obtained in step 1.2 is trained to obtain the word2vec model and the word vector corresponding to each evaluation vocabulary.

The adjectives obtained in step 2.1.1 and the central word in step 2.1.2 are input into the trained word2vec model. The word2vec model outputs the relevant vocabulary of the central word and the similarity between each relevant vocabulary and the central word. In this embodiment, the trained word2vec model will compare the similarity between the adjectives and the central word to get 10 most similar adjectives whose similarity exceed the similarity threshold (0.3) as the related words of the central word.

After merging the related words of the four central words, the words whose frequency is less than the threshold (50) of the word frequency are removed to generate the original vocabulary for imagery. In this embodiment, 27 original vocabulary for imagery words are obtained, and the similarity of the original vocabulary for imagery words is shown in Table 3.

TABLE 3

| Serial number | Vocabulary | Degree of similarity |
|---|---|---|
| 1 | durable | 0.6916132569313049 |
| 2 | texture | 0.6703332662582397 |
| 3 | massiness | 0.6650729775428772 |
| 4 | luxurious | 0.6928253173828125 |
| 5 | clear | 0.617058277130127 |
| 6 | flat | 0.6045259237289429 |
| 7 | flexible | 0.6030625104904175 |
| 8 | fluent | 0.5895933508872986 |
| 9 | stable | 0.5870158672332764 |
| 10 | neatness | 0.7353705167770386 |
| 11 | smooth | 0.5762102603912354 |
| 12 | polished | 0.5554358959197998 |
| 13 | shiny | 0.5390889048576355 |
| 14 | concise | 0.6998268365859985 |
| 15 | new | 0.6709473133087158 |
| 16 | clean | 0.6490770578384399 |
| 17 | fine | 0.5948395133018494 |
| 18 | exquisite | 0.582084059715271 |
| 19 | simple | 0.5592602491378784 |
| 20 | delicate | 0.5155277252197266 |
| 21 | excellent | 0.49254992604255676 |
| 22 | comfortable | 0.4718952775001526 |
| 23 | beautiful | 0.4591400623321533 |
| 24 | simplicity | 0.40623265504837036 |
| 25 | stable | 0.34015771746635437 |
| 26 | meticulous | 0.3228241205215454 |
| 27 | fashionable | 0.3176729083061218 |

Note:
There is a similarity between the original vocabulary for imagery and each central word.

The similarity in the table above is the maximum similarity corresponding to the original vocabulary for imagery.

3. The specific step of clustering the original vocabulary for imagery, and exacting the corresponding original vocabulary for imagery according to a clustering result as a vocabulary for imagery comprising:

3.1. Calculate the Number of Clusters:

The word vector of the original vocabulary for imagery extracted in step 2.2 is extracted to form the word vector data set, and the number of clusters (the optimal number of clusters) of the word vector data set is calculated by python.

Note: In this embodiment, according to the elbow method to get the optimal number of clusters, the core indicator for judging is SSE (sum of the squared errors), and its formula is:

$$SSE = {\sum }_{k = 1}^{K} {\sum }_{p ∈ {C}_{k}} {\vert p - {m}_{k} \vert}^{2} ;$$

In this formula, K is the number of clusters, Cₖ is the Kth cluster, mₖ is a center of mass of the Kth cluster (the mean value of all samples in Ck), and p is the sample point in Cₖ cluster. In this embodiment, the python is used to calculate the value of SSE when the k value is different and draw a line relationship diagram. Since when the K value is less than the real number of cluster, the value of SSE decreases greatly; and when the K value is larger than the real number of cluster, SSE's descending range is sharply reduced and tends to be flat, take the line relationship diagram turning point (“elbow”) for the optimal value of K.

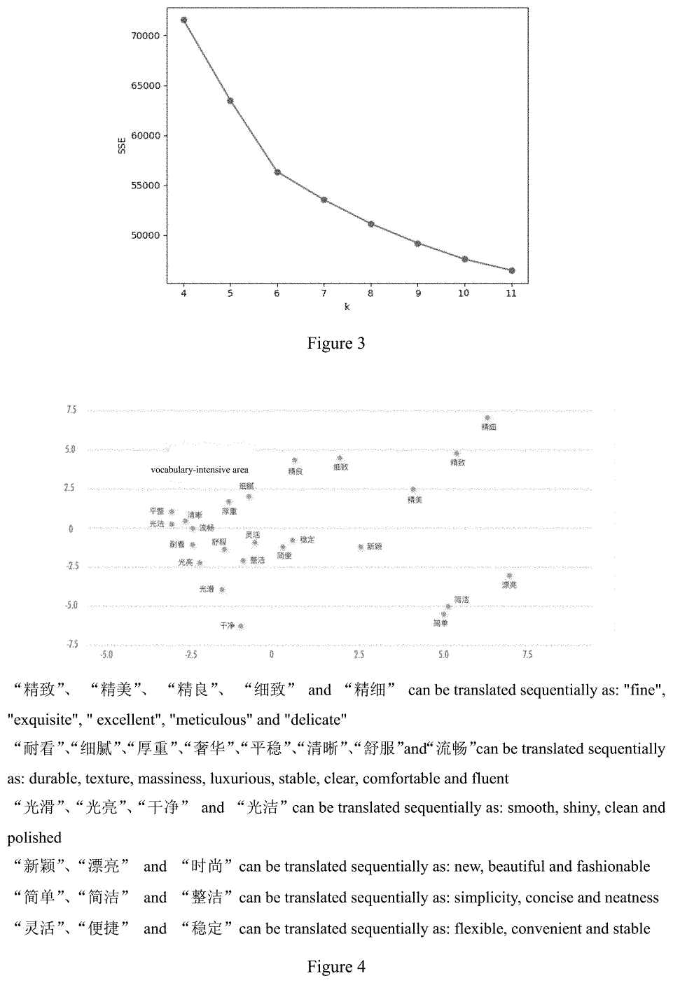

As shown in FIG. 3, the number K calculated in this embodiment is 6, that is, the clustering number is 6.

3.2, K-MEANS clustering;

The word vector data set in step 3.1 is used as the input of K-means Algorithm for clustering and the number of clusters is 6. So that, 6 clusters are obtained.

In this embodiment:

The first cluster includes “ [symbol] ”, “ [symbol] ”, “ [symbol] ”, “ [symbol] ” and “ [symbol] ” (These Chinese can be translated sequentially as: “fine”, “exquisite”, “excellent”, “meticulous” and “delicate”).

The second cluster includes “ [symbol] ”, “ [symbol] ”, “ [symbol] ”, “ [symbol] ”, “ [symbol] ”, “ [symbol] ”, “ [symbol] ” and “ [symbol] [symbol] ”. (These Chinese can be translated sequentially as: durable, texture, massiness, luxurious, stable, clear, comfortable and fluent)

The third cluster includes “ [symbol] ”, “ [symbol] ”, “ [symbol] ” and “ [symbol] ” (These Chinese can be translated sequentially as: smooth, shiny, clean and polished).

The fourth cluster includes “ [symbol] ”, “ [symbol] ” and “ [symbol] ” (These Chinese can be translated sequentially as: new, beautiful and fashionable).

The fifth cluster is “ [symbol] ”, “ [symbol] ” and “ [symbol] ” (These Chinese can be translated sequentially as: simplicity, concise and neatness).

The sixth cluster is “ [symbol] ”, “ [symbol] ” and “ [symbol] ” (These Chinese can be translated sequentially as: flexible, convenient and stable).

The cluster centers of each cluster are obtained, and the original vocabulary for imagery nearest to the cluster centers are extracted as vocabulary for imagery. In this embodiment, the vocabulary for imagery are “ [symbol] ”, “ [symbol] ”, “ [symbol] ”, “ [symbol] ”, “ [symbol] ” and “ [symbol] ” (These Chinese can be translated sequentially as: fine, smooth, concise, luxurious, fashionable and stable).

4. Visualization:

The clustering result in step 3.2 is visualized by python to reduce the dimension of the word vector of each original kansei vocabulary from 64 to 2, making the words represented by each word vector can be displayed in two-dimensional form in the coordinate map, and generating the vocabulary for imagery space map. As shown in FIG. 4, the designer can quickly and accurately grasp the user needs to design the target product according to the distribution and classification of the vocabulary for imagery.

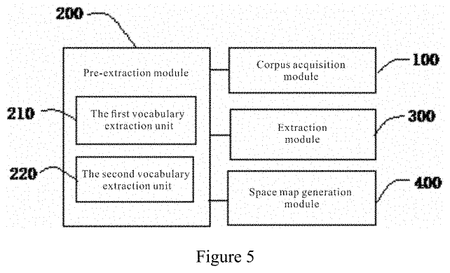

The embodiment two, a system for extracting vocabulary for imagery of a product, as shown in FIG. 5, includes the corpus acquisition module 100, the pre-extraction Module 200, the extraction module 300 and the space map generation module 400.

The corpus acquisition module 100 is used for acquiring the evaluation vocabulary, collecting a comment text data of a target product, and segmenting the comment text data to obtain an evaluation vocabulary;

The pre-extraction module 200 is used for extracting a high-frequency word used to evaluate an appearance as a central word from the evaluation vocabulary, and extracting an adjective from the evaluation vocabulary to obtain the adjectives; converting the evaluation vocabulary into a word vector, calculating a similarity between each adjectives and the central word based on the word vector, and extracting a corresponding adjectives according to the similarity as an original vocabulary for imagery;

The extraction module 300 is used for clustering the original vocabulary for imagery, and exacting the corresponding original vocabulary for imagery according to a clustering result as a vocabulary for imagery.

Further, the pre-extraction module 200 comprises a first vocabulary extraction unit 210 and a second vocabulary extraction unit 220;

the first vocabulary extraction unit 210 is configured to:

classifying the evaluation vocabulary according to a part of speech, extracting the evaluation vocabulary with the part of speech as an adjective to obtain the adjectives, and extracting the evaluation vocabulary with the part of speech as an noun or a verb; eliminating a word referring to the target product from a extracted nouns and a extracted verbs and obtaining a basic word;

counting a word frequency of each basic word in the evaluation vocabulary, extracting a corresponding basic word according to the word frequency to obtain high-frequency words, and selecting a word for evaluating appearance and filtering out from the high-frequency words as the central word;

the second vocabulary extraction unit 220 is configured to:

calculating a cosine similarity between the word vector corresponding to the central word and the word vector corresponding to each adjectives, taking a calculation result as the similarity between the central word and the adjectives; extracting the adjectives having a similarity exceeding a preset similarity threshold as a related word, and obtaining a word frequency of each related word occurring in the evaluation vocabulary;

merging the related words corresponding to each central word, extracting the related words with the word frequency exceeding a preset word frequency threshold, and obtaining the original vocabulary for imagery.

Further, the space map generation module 400 is configured to:

performing dimension reduction processing on the word vector of the original vocabulary for imagery to obtain a corresponding coordinate point;

mapping the coordinate point to a two-dimensional plane according to a clustering result, and generating and outputting a space map of a vocabulary for imagery.

Embodiment 3, a computer readable storage medium which stores a computer program, and the program is executed by a processor to implement the steps of the method of embodiment 1.

For the device embodiment, the description is simple because it is basically similar to the method embodiment, and the correlation can be found in the part description of the method embodiment. Each of the embodiments in this specification is described in a progressive manner. Each embodiment highlights its differences from other embodiments, and the same and similar parts of each embodiment can be referred to each other.

Technicians in this field shall understand that embodiments of the invention may be provided as methods, devices, or computer program products. Therefore, the invention may take the form of a complete hardware embodiment, a complete software embodiment, or an embodiment incorporating both software and hardware aspects. And, the invention may take the form of a computer program product implemented on one or more computer available storage media containing computer available program code, including, but not limited to, disk memory, CD-ROM, optical memory, etc.

The invention is described with reference to the method of the invention, the flow chart and/or block diagram of the terminal equipment (system) and the computer program product. It should be understood that the combination of each flow and/or box in a flow chart and/or block diagram and the flow and/or box in a flow chart and/or block diagram can be achieved by computer programming instructions. These computer program instructions may be provided to a processor of a general-purpose computer, special-purpose computer, embedded processor, or other programmable data-processing terminal device to produce a machine. This machine enables instructions to be executed by a processor on a computer or other programmable data processing terminal device to produce functions specified in the device used to complete one or more processes of a flowchart and/or one or more boxes on a block diagram.

These computer program instructions may also be stored in a computer readable memory that can guide a computer or other programmable data processing terminal device to work in a specific manner. These enable the instructions stored in the computer's readable memory to produce manufactured products including instruction devices that perform functions specified in one or more processes of a flowchart and/or one or more boxes in a block diagram.

These computer program instructions can also be loaded onto a computer or other programmable data processing terminal, enabling a series of operations to be performed on a computer or other programmable terminal to produce computer-implemented processing, thus instructions executed on a computer or other programmable terminal device provide the steps used to implement the functions specified in one or more processes of a flowchart and/or one or more boxes in a block diagram.

Here's the thing:

“One embodiment” or “the embodiment” referred to in the specification means that a specific feature, structure or characteristic described in conjunction with the embodiment is included in at least one embodiment of the invention. Thus, the phrase “one embodiment” or “the embodiment” that appears throughout the specification does not necessarily mean the same embodiment. Although preferred embodiments of the invention have been described, additional changes and modifications to these embodiments can be made by technicians in this field once they are aware of the basic creative concepts. The appended claim is therefore intended to be interpreted to include preferred embodiments and all changes and modifications falling within the scope of the invention.

In addition, it is stated that the specific embodiments described in this instruction may vary in their parts, shapes, names, etc. Any equivalent or simple changes in the structure, characteristics and principles described in the invention patent concept are included in the scope of protection of the invention patent. The technical personnel of the technical field of the invention may make various modifications or supplements to the specific embodiment described or adopt a similar method instead, as long as it does not deviate from the structure of the invention or goes beyond the scope defined in this claim, it shall be within the protection scope of the invention.

1. A method of extracting vocabulary for imagery of product comprising the steps of:
collecting a comment text data of a target product, and segmenting the comment text data to obtain an evaluation vocabulary;
extracting a high-frequency word used to evaluate an appearance as a central word from the evaluation vocabulary, and extracting an adjective from the evaluation vocabulary to obtain an adjectives; converting the evaluation vocabulary into a word vector, calculating a similarity between each adjectives and the central word based on the word vector, and extracting a corresponding adjectives according to the similarity as an original vocabulary for imagery; and
clustering the original vocabulary for imagery, and exacting a corresponding original vocabulary for imagery according to a clustering result as a vocabulary for imagery.

2. The method of extracting vocabulary for imagery of product according to claim 1, wherein calculating a similarity between each adjectives and the central word based on the word vector, and extracting a corresponding adjectives according to the similarity as an original vocabulary for imagery comprises:
calculating a cosine similarity between the word vector corresponding to the central word and the word vector corresponding to each adjectives, taking a calculation result as the similarity between the central word and the adjectives; extracting the adjectives having a similarity exceeding a preset similarity threshold as a related word, and obtaining a word frequency of each related word occurring in the evaluation vocabulary;
merging the related words corresponding to each central word, extracting the related words with the word frequency exceeding a preset word frequency threshold, and obtaining the original vocabulary for imagery.

3. The method of extracting vocabulary for imagery of product according to claim 1, wherein clustering the original vocabulary for imagery, and exacting the corresponding original vocabulary for imagery according to a clustering result as a vocabulary for imagery comprising:
calculating a clustering number based on the word vector of the original vocabulary for imagery;
clustering the original vocabulary for imagery according to the word vector of the original vocabulary for imagery, obtaining a corresponding number of clusters and obtaining a cluster center of each cluster, extracting the original vocabulary for imagery closest to the cluster center of each cluster, and generating and outputting the vocabulary for imagery.

4. The method of extracting vocabulary for imagery of product according to claim 1, wherein extracting a high-frequency word used to evaluate an appearance as a central word from the evaluation vocabulary, and extracting an adjective from the evaluation vocabulary to obtain the adjectives comprising:
classifying the evaluation vocabulary according to a part of speech, extracting the evaluation vocabulary with the part of speech as an adjective to obtain the adjectives, and extracting the evaluation vocabulary with the part of speech as an noun or a verb; eliminating a word referring to the target product from a extracted nouns and a extracted verbs and obtaining a basic word;
counting a word frequency of each basic word in the evaluation vocabulary, extracting a corresponding basic word according to the word frequency to obtain high-frequency words, and selecting a word for evaluating appearance and filtering out from the high-frequency words as the central word.

5. The method of extracting vocabulary for imagery of product according to claim 1, wherein the evaluation vocabulary is converted into a word vector based on word2vec model.

6. The method of extracting vocabulary for imagery of product according to claim 1, wherein clustering the original vocabulary for imagery, and exacting the corresponding original vocabulary for imagery according to a clustering result as a vocabulary for imagery is followed by a visualization processing step, and the step comprises:
performing dimension reduction processing on the word vector of the original vocabulary for imagery to obtain a corresponding coordinate point;
mapping the coordinate point to a two-dimensional plane according to a clustering result, and generating and outputting a space map of a vocabulary for imagery.

7. A system of extracting vocabulary for imagery of product, comprising:
a corpus acquisition module is used for acquiring the evaluation vocabulary, collecting a comment text data of a target product, and segmenting the comment text data to obtain an evaluation vocabulary;
a pre-extraction module for extracting a high-frequency word used to evaluate an appearance as a central word from the evaluation vocabulary, and extracting an adjective from the evaluation vocabulary to obtain the adjectives; converting the evaluation vocabulary into a word vector, calculating a similarity between each adjectives and the central word based on the word vector, and extracting a corresponding adjectives according to the similarity as an original vocabulary for imagery;
a extraction module for clustering the original vocabulary for imagery, and exacting the corresponding original vocabulary for imagery according to a clustering result as a vocabulary for imagery.

8. The system for extracting vocabulary for imagery of product according to claim 7, wherein the pre-extraction module comprises a first vocabulary extraction unit and a second vocabulary extraction unit;
the first vocabulary extraction unit is configured to:
classifying the evaluation vocabulary according to a part of speech, extracting the evaluation vocabulary with the part of speech as an adjective to obtain the adjectives, and extracting the evaluation vocabulary with the part of speech as an noun or a verb; eliminating a word referring to the target product from a extracted nouns and a extracted verbs and obtaining a basic word;
counting a word frequency of each basic word in the evaluation vocabulary, extracting a corresponding basic word according to the word frequency to obtain high-frequency words, and selecting a word for evaluating appearance and filtering out from the high-frequency words as the central word;
the second vocabulary extraction unit is configured to:
calculating a cosine similarity between the word vector corresponding to the central word and the word vector corresponding to each adjectives, taking a calculation result as the similarity between the central word and the adjectives; extracting the adjectives having a similarity exceeding a preset similarity threshold as a related word, and obtaining a word frequency of each related word occurring in the evaluation vocabulary;
merging the related words corresponding to each central word, extracting the related words with the word frequency exceeding a preset word frequency threshold, and obtaining the original vocabulary for imagery.

9. The system for extracting vocabulary for imagery of product according to claim 7, wherein further comprises a space map generation module, the space map generation module is configured to:
performing dimension reduction processing on the word vector of the original vocabulary for imagery to obtain a corresponding coordinate point;
mapping the coordinate point to a two-dimensional plane according to a clustering result, and generating and outputting a space map of a vocabulary for imagery.

10. A computer readable storage medium storing a computer program, wherein the program is executed by a processor to implement the steps of the method of claim 1.

11. The computer readable storage medium storing a computer program according to claim 10, wherein calculating a similarity between each adjectives and the central word based on the word vector, and extracting a corresponding adjectives according to the similarity as an original vocabulary for imagery comprises:
calculating a cosine similarity between the word vector corresponding to the central word and the word vector corresponding to each adjectives, taking a calculation result as the similarity between the central word and the adjectives; extracting the adjectives having a similarity exceeding a preset similarity threshold as a related word, and obtaining a word frequency of each related word occurring in the evaluation vocabulary;
merging the related words corresponding to each central word, extracting the related words with the word frequency exceeding a preset word frequency threshold, and obtaining the original vocabulary for imagery.

12. The computer readable storage medium storing a computer program according to claim 10, wherein clustering the original vocabulary for imagery, and exacting the corresponding original vocabulary for imagery according to a clustering result as a vocabulary for imagery comprising:
calculating a clustering number based on the word vector of the original vocabulary for imagery;
clustering the original vocabulary for imagery according to the word vector of the original vocabulary for imagery, obtaining a corresponding number of clusters and obtaining a cluster center of each cluster, extracting the original vocabulary for imagery closest to the cluster center of each cluster, and generating and outputting the vocabulary for imagery.

13. The computer readable storage medium storing a computer program according to claim 10, wherein extracting a high-frequency word used to evaluate an appearance as a central word from the evaluation vocabulary, and extracting an adjective from the evaluation vocabulary to obtain the adjectives comprising:
classifying the evaluation vocabulary according to a part of speech, extracting the evaluation vocabulary with the part of speech as an adjective to obtain the adjectives, and extracting the evaluation vocabulary with the part of speech as an noun or a verb; eliminating a word referring to the target product from a extracted nouns and a extracted verbs and obtaining a basic word;
counting a word frequency of each basic word in the evaluation vocabulary, extracting a corresponding basic word according to the word frequency to obtain high-frequency words, and selecting a word for evaluating appearance and filtering out from the high-frequency words as the central word.

14. The computer readable storage medium storing a computer program according to claim 10, wherein the evaluation vocabulary is converted into a word vector based on word2vec model.

15. The computer readable storage medium storing a computer program according to claim 10, wherein clustering the original vocabulary for imagery, and exacting the corresponding original vocabulary for imagery according to a clustering result as a vocabulary for imagery is followed by a visualization processing step, and the step comprises:
performing dimension reduction processing on the word vector of the original vocabulary for imagery to obtain a corresponding coordinate point;
mapping the coordinate point to a two-dimensional plane according to a clustering result, and generating and outputting a space map of a vocabulary for imagery.
